(19) United States
(12) Patent Application Publication
(10) Pub. No.: US 2023/0112118 A1
(43) Pub. Date: Apr. 13, 2023

(54) PNEUMATIC TIRE

(71) Applicant: The Yokohama Rubber Co., LTD., Tokyo (JP)

(72) Inventor: Keisuke NAKAZAKI, Kanagawa (JP)

(21) Appl. No.: 17/907,349

(22) PCT Filed: Mar. 16, 2021
(86) PCT No.: PCT/JP2021/010707

§ 371 Date: Sep. 26, 2022

(30) Foreign Application Priority Data
Apr. 1, 2020 (JP) 2020-066169

(51) Int. Cl. B60C 11/00; B60C 1/00

(52) U.S. Cl. CPC B60C 11/005; B60C 1/0016; B60C 11/0008; B60C 2011/0025

(57) ABSTRACT

To provide a pneumatic tire in which the rolling resistance coefficient is reduced while maintaining steering stability. A total gauge TOGa of a cap tread rubber (11A) and an undertread rubber (11B) and a gauge UTGa of the undertread rubber (11B) satisfy a relationship 0.20 ≤ UTGa/TOGa ≤ 0.40 in a ground contact region defined by a pair of shoulder main grooves (10B) located on both outermost sides in a tire width direction in a tread portion (1). A hardness UTHs of the undertread rubber (11B) is in a range of 62 or more and 67 or less. The hardness UTHs of the undertread rubber (11B) and a hardness CapHs of the cap tread rubber (11A) satisfy a relationship 0.90 ≤ CapHs/UTHs ≤ 1.20. A tan δ (60° C.) of the undertread rubber (11B) is less than 0.06.

### TECHNICAL FIELD

The present technology relates to a pneumatic tire including a tread portion in which a cap tread rubber and an undertread rubber are layered.

### BACKGROUND ART

In recent years, the rolling resistance coefficient (RRC) of pneumatic tires has been reduced for the purpose of improving the fuel efficiency of a vehicle. In this type of pneumatic tire, a cap tread rubber and an undertread rubber are layered to form a tread portion, and a technique in which the rolling resistance coefficient is reduced by relatively increasing a gauge (thickness) of the undertread rubber has been proposed (for example, see Japan Patent No. 6158467 B).

However, in conventional configurations, the hardness of the undertread rubber is lower (softer) than that of the cap tread rubber, and there is a concern that simply increasing the gauge of the undertread rubber may deteriorate steering stability.

### SUMMARY

The present technology provides a pneumatic tire in which the rolling resistance coefficient is reduced while maintaining steering stability.

A pneumatic tire according to an embodiment of the present technology includes a tread portion extending in a tire circumferential direction and having an annular shape, and a plurality of main grooves formed in the tread portion and extending in the tire circumferential direction. The tread portion includes a cap tread rubber disposed at least on an outer side in a tire radial direction, and an undertread rubber disposed on an inner side in the tire radial direction of the cap tread rubber. A total gauge TOGa of the cap tread rubber and the undertread rubber and a gauge UTGa of the undertread rubber satisfy a relationship 0.20 ≤ UTGa/TOGa ≤ 0.40 in a ground contact region defined by a pair of the main grooves located on both outermost sides in a tire width direction in the tread portion. A hardness UTHs of the undertread rubberis in a range of 62 or more and 67 or less. The hardness UTHs of the undertread rubber and a hardness CapHs of the cap tread rubber satisfy a relationship 0.90 < CapHs/UTHs ≤ 1.20. A tan δ (60° C.) of the undertread rubber is less than 0.06.

In the pneumatic tire described above, the undertread rubber preferably contains an amine-based anti-aging agent of 2.0 phr or more.

Further, in the pneumatic tire described above, the cap tread rubber preferably contains an amine-based anti-aging agent of 2.0 phr or more.

Furthermore, in the pneumatic tire described above, a content CPM of the amine-based anti-aging agent of the cap tread rubber and a content UTM of the amine-based anti-aging agent of the undertread rubber preferably satisfy a relationship 0.5 ≤ (UTM/CPM) ≤ 1.5.

Additionally, in the pneumatic tire described above, the total gauge TOGa of the cap tread rubber and the undertread rubber, the gauge UTGa of the undertread rubber, and a tread width TW of the tread portion preferably satisfy a relationship 0.0012 ≤ (UTGa/TOGa)/TW ≤ 0.0040.

Further, in the pneumatic tire described above, a tan δ (60° C.) of the cap tread rubber is preferably 0.10 or more and 0.30 or less.

Furthermore, in the pneumatic tire described above, an average groove depth GD of the main groove and a gauge CPGa of the cap tread rubber preferably satisfy a relationship 1.0 ≤ (GD/CPGa) ≤ 1.3.

Additionally, in the pneumatic tire described above, 50 parts by mass or more of carbon black having a nitrogen adsorption specific surface area N ₂SA of 70 m²/g or less is preferably blended per 100 parts by mass of a rubber component comprising 50 mass% or more natural rubber and 35 mass% or more and 50 mass% or less terminal-modified butadiene rubber into the undertread rubber, and a modulus of repulsion elasticity of the undertread rubber at 40° C. is preferably 80% or more.

Furthermore, the pneumatic tire described above is preferably a summer tire or an all-season tire.

In the pneumatic tire according to an embodiment of the present technology, the total gauge TOGa of the cap tread rubber and the undertread rubber and the gauge UTGa of the undertread rubber satisfy the relationship 0.20 ≤ UTGa/TOGa ≤ 0.40 in the ground contact region defined by a pair of the main grooves located on the both outermost sides in the tire width direction in the tread portion. The hardness UTHs of the undertread rubber is in the range of 62 or more and 67 or less. The hardness UTHs of the undertread rubber and the hardness CapHs of the cap tread rubber satisfy the relationship 0.90 ≤ CapHs/UTHs ≤ 1.20. The tan δ (60° C.) of the undertread rubber is less than 0.06. As a result, the rolling resistance coefficient can be reduced while maintaining steering stability.

### BRIEF DESCRIPTION OF DRAWINGS

FIG. 1 is a meridian cross-sectional view illustrating a pneumatic tire according to the present embodiment.

FIG. 2 is an enlarged cross-sectional view illustrating a main portion of the pneumatic tire of FIG. 1.

FIGS. 3A-3B include a table indicating the results of performance tests of pneumatic tires according to the present embodiment.

### DETAILED DESCRIPTION

Embodiments of the present technology will be described in detail below with reference to the drawings. In the embodiments described below, identical or similar components to those of other embodiments have identical reference signs, and descriptions of those components will be either simplified or omitted. The present technology is not limited by the embodiments. Constituents of the embodiments include elements that are substantially identical or that can be substituted and easily conceived by one skilled in the art.

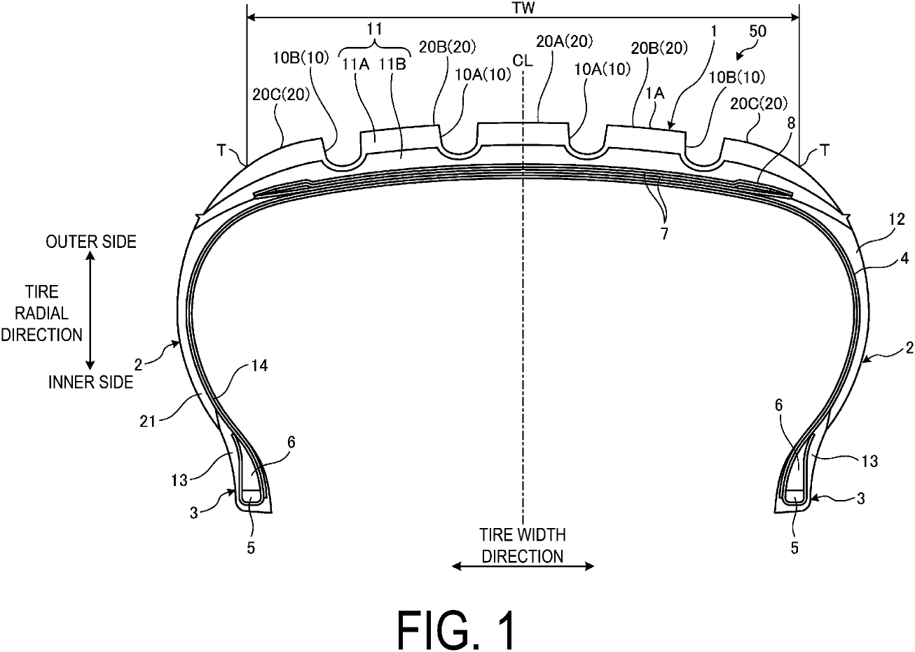

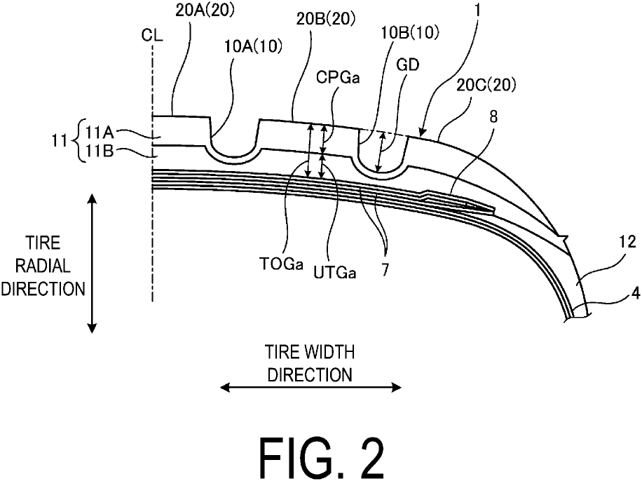

FIG. 1 is a meridian cross-sectional view illustrating a pneumatic tire according to the present embodiment. FIG. 2 is an enlarged cross-sectional view illustrating a main portion of the pneumatic tire of FIG. 1. In FIG. 1, the “meridian cross-section” refers to a cross-section of the tire taken along a plane that includes a tire rotation axis (not illustrated). Additionally, reference sign CL indicates a tire equatorial plane and refers to a plane that passes through the center point of the tire in the tire rotation axis direction and is perpendicular to the tire rotation axis. Additionally, the tire width direction refers to a direction parallel with the tire rotation axis, the inner side in the tire width direction refers to the side toward the tire equatorial plane CL in the tire width direction, and the outer side in the tire width direction refers to the side away from the tire equatorial plane CL in the tire width direction. The tire radial direction refers to a direction perpendicular to the tire rotation axis, the inner side in the tire radial direction refers to the side toward the rotation axis in the tire radial direction, and the outer side in the tire radial direction refers to the side away from the rotation axis in the tire radial direction.

The pneumatic tire according to the present embodiment is directed to a tire that is a so-called summer tire or an all-season tire, and does not include a studless tire (snow tire). In addition, the pneumatic tire according to the present embodiment is mounted on a vehicle that is generally referred to as a passenger vehicle or a small passenger vehicle, and is particularly suitable for a vehicle such as a so-called small vehicle or compact car (an A-segment vehicle).

As illustrated in FIG. 1, a pneumatic tire 50 includes a tread portion 1 extending in a tire circumferential direction and having an annular shape, a pair of sidewall portions 2, 2 disposed on both sides of the tread portion 1, and a pair of bead portions 3, 3 disposed on an inner side in the tire radial direction of the sidewall portions 2.

At least one carcass layer 4 is mounted between the pair of bead portions 3, 3. The carcass layer 4 includes a plurality of reinforcing cords extending in the tire radial direction, and is folded back from the tire inner side to the tire outer side around bead cores 5 disposed in the respective bead portions 3. A bead filler 6 having a triangular cross-sectional shape and formed of a rubber composition is disposed on the outer circumference of the bead core 5.

On the other hand, a plurality of belt layers 7 are embedded on the outer circumferential side of the carcass layer 4 in the tread portion 1. The belt layers 7 include a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set in a range of, for example, not less than 10° and not greater than 40°. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, but the pneumatic tire is not limited thereto.

In the pneumatic tire described above, a plurality of main grooves 10 (four main grooves in FIG. 1) extending in the tire circumferential direction are formed in the tread portion 1. The main grooves 10 are grooves each provided with wear indicators (not illustrated) at predetermined intervals in the tire circumferential direction. The main grooves 10 include two center main grooves 10A located on the inner side in the tire width direction with the tire equatorial plane CL interposed therebetween, and two shoulder main grooves 10B each located on the outer side in the tire width direction of the center main groove 10A. The shoulder main groove 10B corresponds to a main groove located on the outermost side in the tire width direction. In a case where it is not necessary to distinguish the center main groove 10A from the shoulder main groove 10B, the center main groove 10A and the shoulder main groove 10B are simply referred to as the main groove 10. In addition, lug grooves extending in the tire width direction are formed as grooves other than the main grooves 10 in the tread portion 1.

The two center main grooves 10A and the two shoulder main grooves 10B are formed in the tread portion 1, and thus a plurality of land portions 20 (five land portions in FIG. 1) are defined therein. Specifically, the land portions 20 include a center land portion 20A extending in the tire circumferential direction between the pair of center main grooves 10A, 10A, second land portions 20B each extending in the tire circumferential direction between the center main groove 10A and the shoulder main groove 10B, and shoulder land portions 20C each located on the outer side in the tire radial direction of the shoulder main groove 10B and extending in the tire circumferential direction. In a case where the center land portion 20A, the second land portion 20B, and the shoulder land portion 20C are not distinguished from one another, the center land portion 20A, the second land portion 20B, and the shoulder land portion 20C are simply referred to as the land portion 20.

In the pneumatic tire 50 described above, a tread rubber layer 11 is disposed on outer side of the carcass layer 4, the belt layers 7, and the belt cover layer 8 in the tread portion 1. A side rubber layer 12 is disposed on outer side of the carcass layer 4 in the sidewall portion 2. A rim cushion rubber layer 13 is disposed on an outer side of the carcass layer 4 in the bead portion 3. Additionally, on a tire inner wall, an innerliner layer 14 is disposed along the carcass layer 4.

As illustrated in FIG. 2, the tread rubber layer 11 includes a multilayer structure of at least two layers, and includes a cap tread rubber 11A located on the outermost side in the tire radial direction and an undertread rubber 11B adj acent to the cap tread rubber 11A on the inner side in the tire radial direction. The cap tread rubber 11A is made of a rubber material excellent in ground contact characteristics and weather resistance, and is exposed to a surface (also referred to as a tread surface, a road contact surface) 1A of the tread portion 1 to come into contact with the road surface during travel. Additionally, various grooves such as the main grooves 10 of the tread portion 1 and lug grooves are mainly formed in the cap tread rubber 11A. The undertread rubber 11B is disposed between the cap tread rubber 11A and the belt layers 7 to form a base portion of the tread rubber layer 11.

Incidentally, in pneumatic tires used as summer tires or all-season tires, a configuration is being explored in which steering stability and reduction of the rolling resistance coefficient are achieved in a compatible manner for the purpose of improving the fuel efficiency of a vehicle. In the present configuration, by respectively improving the gauge (thickness), hardness, and a tan δ (loss tangent) value of the undertread rubber 11B in the tread rubber layer 11, the rolling resistance coefficient is reduced while good steering stability is ensured.

Specifically, in the pneumatic tire 50 described above, a total gauge TOGa of the cap tread rubber 11A and the undertread rubber 11B and a gauge UTGa of the undertread rubber 11B satisfy the relationship 0.20 ≤ UTGa/TOGa ≤ 0.40. The total gauge TOGais the sum (CPGa + UTGa = TOGa) of a gauge CPGa of the cap tread rubber 11A and the gauge UTGa of the undertread rubber 11B. Accordingly, in the present configuration, the total gauge TOGa and the gauge CPGa of the cap tread rubber 11A satisfy 0.60 ≤ CPGa/TOGa ≤ 0.80.

As just described, by setting the gauge UTGa of the undertread rubber 11B relative to the total gauge TOGa to be relatively thick, the tread rubber layer 11 can achieve a reduction in the rolling resistance coefficient. Note that the gauge of each rubber is the average thickness measured in a ground contact region between the two shoulder main grooves 10B, 10B of the tread portion 1, more specifically, in a central portion in the tire width direction (a range of 25% from the center to both outer sides in the width direction) of each land portion 20.

The ground contact region is the region defined by ground contact edges T located on both outermost ends in the tire width direction, and is the region where the tread surface of the tread portion 1 of the pneumatic tire 50 comes into contact with a dry, flat road surface when the pneumatic tire 50 is mounted on a specified rim, inflated to a specified internal pressure, and loaded with 70% of a specified load. Here, “specified rim” refers to a “standard rim” defined by the Japan Automobile Tyre Manufacturers Association Inc. (JATMA), a “design rim” defined by the Tire and Rim Association, Inc. (TRA), or a “measuring rim” defined by the European Tyre and Rim Technical Organization (ETRTO). Moreover, the specified internal pressure refers to a “maximum air pressure” defined by JATMA, a maximum value in “TIRE LOAD LIMITS AT VARIOUS COLD INFLATION PRESSURES” defined by TRA, or “INFLATION PRESSURES” defined by ETRTO. Moreover, “Specified load” refers to a “maximum load capacity” defined by JATMA, the maximum value in “TIRE LOAD LIMITS AT VARIOUS COLD INFLATION PRESSURES” defined by TRA, or “LOAD CAPACITY” defined by ETRTO.

Further, in the pneumatic tire 50 described above, a hardness UTHs of the undertread rubber 11B is set in the range of 62 or more and 67 or less. Furthermore, the hardness UTHs of the undertread rubber 11B and a hardness CapHs of the cap tread rubber 11A satisfy the relationship 0.90 ≤ CapHs/UTHs ≤ 1.20. Here, the hardness is the durometer hardness measured in accordance with JIS (Japanese Industrial Standard)-K6253 using a type A durometer and under a temperature of 23° C. and is also referred to as JIS hardness. In this configuration, the undertread rubber 11B has a relatively high hardness (medium hardness), and the undertread rubber 11B and the cap tread rubber 11A are set to have equal hardness. As a result, the rigidity of the tread portion 1 can be ensured and good steering stability can be ensured.

Additionally, in the pneumatic tire 50 described above, a tan δ (60° C.) of the undertread rubber 11B is set to a value smaller than a tan δ (60° C.) of the cap tread rubber 11A. Specifically, the tan δ (60° C.) of the undertread rubber 11B is set to be greater than 0 and 0.06 or smaller, and the tan δ (60° C.) of the cap tread rubber 11A is set to 0.10 or more and 0.30 or less. Here, the tan δ (60° C.) refers to a loss tangent (loss modulus/storage modulus) at 60° C., and is an indicator to evaluate the properties of elasticity and viscosity of the rubber material. Typically, the closer the value of the tan δ (60° C.) is to 0, the higher the elasticity is. The greater the value of the tan δ (60° C.) is, the higher the viscosity tends to be. Also, the closer the value of the tan δ (60° C.) is to 0, the lower the heat build-up, and the smaller the rolling resistance coefficient tends to be.

In the present configuration, the total gauge TOGa of the cap tread rubber 11 A and the undertread rubber 11B and the gauge UTGa of the undertread rubber 11B satisfy the relationship 0.20 ≤ UTGa/TOGa ≤ 0.40. The hardness UTHs of the undertread rubber 11B is in the range of 62 or more and 67 or less, and the hardness UTHs of the undertread rubber 11B and the hardness CapHs of the cap tread rubber 11A satisfy the relationship 0.90 ≤ CapHs/UTHs ≤ 1.20. The tan δ (60° C.) of the undertread rubber 11B is 0.06 or less. Consequently, the gauge UTGa of the undertread rubber 11B relative to the total gauge TOGa can be relatively thick, and the hardness UTHs of the undertread rubber 11B can have a medium hardness. In addition, the undertread rubber 11B can have low heat build-up. As a result, the rigidity of the tread portion 1 can be ensured and good steering stability can be ensured, and the rolling resistance coefficient can be reduced.

Here, when UTGa/TOGa is less than 0.20, the amount of undertread rubber is small, and thus the effect of reducing the rolling resistance coefficient is not sufficient. Also, when UTGa/TOGa is greater than 0.40, the amount of undertread rubber is too large, and thus the steering stability is reduced. Further, when the hardness UTHs of the undertread rubber 11B is less than 62, the rigidity of the tread portion 1 is insufficient, and thus the steering stability is reduced. Also, when the hardness UTHs is greater than 67, there is a problem that low heat build-up of the undertread rubber cannot be maintained and thus the rolling resistance coefficient deteriorates. Furthermore, when the CapHs/UTHsis less than 0.90, there is a problem that the cap tread rubber 11A is too soft with respect to the undertread rubber 11B and thus the steering stability cannot be maintained. Also, when the CapHs/UTHs is greater than 1.20, the undertread rubber 11B is too soft with respect to the cap tread rubber 11A, and thus the rigidity of the tread portion 1 is insufficient to deteriorate the steering stability. In addition, when the tan δ (60° C.) of the undertread rubber 11B is greater than 0.06, there is a problem that heat build-up of the undertread rubber 11B is high and thus the rolling resistance coefficient deteriorates.

Moreover, in the present configuration, since the tan δ (60° C.) of the cap tread rubber 11Ais set to be 0.10 or more and 0.30 or less, rubber having a relatively high viscosity can be used as the cap tread rubber 11A, increasing the friction force of the rubber. As a result, gripping force of the tread portion 1 can be improved, and the steering stability can be improved.

Additionally, the tread portion 1 used in the pneumatic tire 50 described above deteriorates due to various factors such as oxygen, ozone, light, and dynamic fatigue during use. In the present configuration, the cap tread rubber 11A contains an amine-based anti-aging agent of 2.0 phr or more, and the undertread rubber 11B contains an amine-based anti-aging agent of 2.0 phr or more. In other words, the undertread rubber 11B contains the volume of the amine-based anti-aging agent equal to or larger than that of the cap tread rubber 11A. The amine-based anti-aging agent prevents the aging (degradation) of rubber to suppress groove cracking occurring in the groove bottom of the main groove 10 or the like of the tread portion 1. For example, N-phenyl-N′-(1,3-dimethylbutyl)-p-phenylenediamine (brand name: NOCRAC (trade name) 6C) can be used. Note that phr indicates parts by weight of the amine-based anti-aging agent with respect to 100 parts per hundred of the rubber component.

Here, the undertread rubber 11B is not exposed to the outside and the main groove 10 is formed in the cap tread rubber 11A, and thus the amine-based anti-aging agent may be contained only in the cap tread rubber 11Ain order to suppress groove cracking in the groove bottom of the main groove 10. However, in a case where the amine-based anti-aging agent is contained only in the cap tread rubber 11A, it has been found that the amine-based anti-aging agent flows out from the cap tread rubber 11Ato the undertread rubber 11B (also referred to as migration) and thus the content of the amine-based anti-aging agent of the cap tread rubber 11A decreases to generate groove cracking. Accordingly, in the present configuration, by allowing the amine-based anti-aging agent of 2.0 phr or more to be contained into the undertread rubber 11B, the migration of the amine-based anti-aging agent from the cap tread rubber 11A to the undertread rubber 11B can be suppressed, and groove cracking occurring in the groove bottom of the main groove 10 can be suppressed.

Here, when the content of the amine-based anti-aging agent of the undertread rubber 11B is less than 2.0 phr, there may occur a problem that groove cracking is likely to occur in the groove bottom of the main groove 10 due to a lack of the anti-aging agent. Consequently, the content of the amine-based anti-aging agent of the undertread rubber 11B is preferably 2.0 phr or more. Further, a content CPM of the amine-based anti-aging agent of the cap tread rubber 11A and a content UTM of the amine-based anti-aging agent of the undertread rubber 11B preferably satisfy the relationship 0.5 ≤ (UTM/CPM) ≤ 1.5.

Furthermore, in the pneumatic tire 50 described above, the total gauge TOGa of the cap tread rubber 11A and the undertread rubber 11B, the gauge UTGa of the undertread rubber 11B, and a tread width TW of the tread portion 1 preferably satisfy the relationship 0.0012 ≤ (UTGa/TOGa)/TW≤ 0.0040. As illustrated in FIG. 1, the tread width TW is the distance between the ground contact edges T, T of the tread portion 1 in the tire width direction, and is measured in a state where the pneumatic tire 50 is mounted on a specified rim, inflated to a specified internal pressure, and loaded with 70% of a specified load.

As described above, it is suitable for the pneumatic tire 50 according to the present embodiment to be mounted on a small vehicle or a compact car (an A-segment vehicle). A pneumatic tire for a small vehicle or the like has a tread width TW that is narrower than that of a pneumatic tire for a regular passenger vehicle, which is likely to deteriorate steering stability. Also, a pneumatic tire for a small vehicle or the like is required to have a rolling resistance coefficient that is smaller than that of a pneumatic tire for a regular passenger vehicle. Here, when (UTGa/TOGa)/TW is less than 0.0012, the effect of reducing the rolling resistance coefficient may not be sufficiently attained due to the amount of undertread rubber being small with respect to the tread width TW (in other words, tire size). Meanwhile, when (UTGa/TOGa)/TW is greater than 0.0040, the amount of undertread rubber with respect to the tread width TW is large, which may lead to a decrease in steering stability.

In the present configuration, by adjusting the total gauge TOGa of the cap tread rubber 11A and the undertread rubber 11B,the gauge UTGa of the undertread rubber 11B, and the tread width TW of the tread portion 1 in the range to satisfy 0.0012 ≤ (UTGa/TOGa)/TW ≤ 0.0040, the value of the (UTGa/TOGa) with respect to the tread width TW can be relatively large. As a result, even the pneumatic tire 50 mounted on a small vehicle or a compact car can provide ensured good steering stability and reduction of the rolling resistance coefficient in a compatible manner.

Further, in the pneumatic tire 50 described above, the gauge CPGa of the cap tread rubber 11A and an average groove depth GD of the main grooves 10 preferably satisfy 1.0 ≤ (GD/CPGa) ≤ 1.3, and the average groove depth GD of the main grooves 10 is preferably in the range of 5.0 mm or more and 9.0 mm or less. Accordingly, the gauge CPGa of the cap tread rubber 11A can be optimized with respect to the average groove depth GD of the main grooves 10, and the steering stability can be improved.

Furthermore, in the pneumatic tire 50 described above, a rubber component of a rubber composition for a tire used in the undertread rubber 11B is a diene rubber that surely includes a natural rubber and a terminal-modified butadiene rubber. As anatural rubber, a rubber that is typically used in rubber compositions for tires can be used. By allowing a natural rubber to be blended, sufficient rubber strength as a rubber composition for tires can be achieved. When the entire diene rubber is 100 mass%, the blended amount of the natural rubber is 50 mass% or more, preferably 50 mass% or more and 70 mass% or less, and more preferably 60 mass% or more and 65 mass% or less. When the blended amount of the natural rubber is less than 50 mass%, the rubber strength is reduced.

The terminal-modified butadiene rubber is a butadiene rubber in which one terminal or both terminals of the molecular chain is modified with an organic compound having a functional group. By blending such a terminal-modified butadiene rubber, affinity with carbon black described below is increased and dispersibility is improved. Accordingly, the effect of the carbon black is further improved while heat build-up is maintained at a low level, and thus the rubber hardness can be increased. At least one selected, for example, from a hydroxyl group (hydroxy group), an amino group, an amide group, an alkoxyl group, an epoxy group, and a siloxane linking group is applied as a functional group that allows for terminal-modification of the molecular chain. Note that the siloxane linking group is a functional group having an -O-Si-O-structure.

When the entire diene rubber is 100 mass%, the blended amount of the terminal-modified butadiene rubber is 35 mass% or more and 50 mass% or less, and preferably 40 mass% or more and 50 mass% or less. When the blended amount of the terminal-modified butadiene rubber is less than 35 mass%, the fuel efficiency deteriorates. When the blended amount of the terminal-modified butadiene rubber is greater than 50 mass%, the rubber strength is reduced.

The molecular weight distribution (Mw/Mn) of the terminal-modified butadiene rubber is preferably 2.0 or less, and more preferably 1.1 or more and 1.6 or less. As described above, by using a terminal-modified butadiene rubber having a narrow molecular weight distribution, even better rubber physical properties are achieved, and thus the steering stability and the durability can be effectively enhanced in tires while the rolling resistance is reduced. When the molecular weight distribution (Mw/Mn) of the terminal-modified butadiene rubber is greater than 2.0, a hysteresis loss becomes greater and heat build-up of the rubber becomes greater, and compression set resistance is reduced.

The glass transition temperature Tg of the terminal-modified butadiene rubber used in the present configuration is preferably -85° C. or lower, and more preferably -100° C. or higher and -90° C. or lower. By setting the glass transition temperature Tg as described above, the heat build-up can be effectively reduced. When the glass transition temperature Tg is higher than -80° C., the effect of reducing heat build-up cannot be sufficiently obtained. Note that the glass transition temperature Tg of the natural rubber is not particularly limited, but can be set to, for example, -80° C. or higher and -70° C. or lower.

Additionally, the terminal-modified butadiene rubber used in the present configuration preferably has a vinyl content of 0.1 mass% or more and 20 mass% or less, and more preferably has a vinyl content of 0.1 mass% or more and 15 mass% or less. When the vinyl content of the terminal-modified butadiene rubber is less than 0.1 mass%, affinity with carbon black becomes insufficient, which makes it difficult to sufficiently reduce heat build-up. When the vinyl content of the terminal-modified butadiene rubberis greater than 20 mass%, the glass transition temperature Tg of the rubber composition is increased, and the rolling resistance and the wear resistance cannot be adequately improved. Note that the vinyl unit content of the terminal-modified butadiene rubber is measured by infrared spectroscopy (Hampton method). The increase or decrease in the vinyl unit content in the terminal-modified butadiene rubber can be appropriately adjusted by an ordinary method such as a catalyst.

Further, in the pneumatic tire 50 described above, carbon black is necessarily blended as a filler into a rubber composition for a tire used in the undertread rubber 11B. By blending the carbon black, the strength of the rubber composition can be increased. In particular, the carbon black blended into the rubber composition for a tire according to the present configuration has a nitrogen adsorption specific surface area N₂ SA of 70 m²/g or less, preferably 35 m²/g or more and 60 m²/g or less, and more preferably 35 m²/g or more and 50 m²/g or less. By blending a combination of carbon black having such a large particle diameter and the modified butadiene rubber described above, while the heat build-up is maintained low, the rubber hardness can be effectively enhanced. When the nitrogen adsorption specific surface area N₂SA of carbon black is greater than 70 m²/g, heat build-up deteriorates. Note that the nitrogen adsorption specific surface area N₂SA of carbon black is measured in accordance with JIS 6217-2.

The blended amount of carbon black is preferably 50 parts by mass or more per 100 parts by mass of the aforementioned rubber component, preferably 55 parts by mass or more and 65 parts by mass or less, and more preferably 57 parts by mass or more and 60 parts by mass or less. When the blended amount of carbon black is less than 50 parts by mass, the hardness of the undertread rubber 11B is reduced.

Furthermore, in the pneumatic tire 50 described above, the hardness UTHs of the rubber composition for a tire used in the undertread rubber 11B is set in the range of 62 or more and 67 or less as described above, and is preferably 65 or more and 67 or less. Additionally, in the pneumatic tire 50 described above, the rubber composition for a tire used in the undertread rubber 11B has a modulus of repulsion elasticity of 80% or more at 40° C., preferably has a modulus of repulsion elasticity of 80% or more and 85% or less, and more preferably has a modulus of repulsion elasticity of 82% or more and 85% or less. Since the undertread rubber 11B in the present configuration has the physical properties described above, the steering stability can be improved while the rolling resistance coefficient is reduced. When the mo dulus of repulsion elasticity is less than 80%, heat build-up deteriorates, and the rolling resistance coefficient cannot be reduced. Note that these hardness and modulus of repulsion elasticity are not only set by the aforementioned blend and are the physical properties that can be also adjusted, for example, by kneading conditions or kneading methods.

As described above, the pneumatic tire 50 according to the present embodiment includes the tread portion 1 extending in the tire circumferential direction and having an annular shape, and the plurality of main grooves 10 formed in the tread portion 1 and extending in the tire circumferential direction. The tread portion 1 includes at least the cap tread rubber 11A disposed on the outer side in the tire radial direction, and the undertread rubber 11B disposed on the inner side in the tire radial direction of the cap tread rubber 11A. The total gauge TOGa of the cap tread rubber 11A and the undertread rubber 11B and the gauge UTGa of the undertread rubber 11B satisfy the relationship 0.20 ≤ UTGa/TOGa ≤ 0.40 in the ground contact region defined by the pair of the shoulder main grooves 10B located on the both outermost sides in the tire width direction in the tread portion 1. The hardness UTHs of the undertread rubber 11B is in the range of 62 or more and 67 or less. The hardness UTHs of the undertread rubber 11B and the hardness CapHs of the cap tread rubber 11A satisfy the relationship 0.90 ≤ CapHs/UTHs ≤ 1.20. The tan δ (60° C.) of the undertread rubber 11B is less than 0.06. Accordingly, the gauge UTGa of the undertread rubber 11B relative to the total gauge TOGa can be relatively thick, and the hardness UTHs of the undertread rubber 11B can have a medium hardness. In addition, the undertread rubber 11B can have low heat build-up. As a result, the rigidity of the tread portion 1 is ensured and good steering stability can be ensured. In addition, the rolling resistance coefficient can be reduced.

Further, accordingto the present embodiment, the undertread rubber 11B contains an amine-based anti-aging agent of 2.0 phr or more, and the cap tread rubber 11A contains an amine-based anti-aging agent of 2.0 phr or more. Accordingly, the migration of the amine-based anti-aging agent from the cap tread rubber 11A to the undertread rubber 11B can be suppressed, and groove cracking occurring in the groove bottom of the main groove 10 can be suppressed.

Furthermore, according to the present embodiment, the content CPM of the amine-based anti-aging agent of the cap tread rubber 11A and the content UTM of the amine-based anti-aging agent of the undertread rubber 11B satisfy the relationship 0.5 ≤ (UTM/CPM) ≤ 1.5. Accordingly, the migration of the amine-based anti-aging agent from the cap tread rubber 11A to the undertread rubber 11B can be suppressed, and groove cracking occurring in the groove bottom of the main groove 10 can be suppressed.

Additionally, according to the present embodiment, the total gauge TOGa of the cap tread rubber 11A and the undertread rubber 11B, the gauge UTGa of the undertread rubber 11B, and the tread width TW of the tread portion 1 satisfy the relationship 0.0012 ≤ (UTGa/TOGa)/TW ≤ 0.0040. Accordingly, for example, even when being mounted on a small vehicle or a compact car, the pneumatic tire can provide ensured good steering stability and reduction of the rolling resistance coefficient in a compatible manner.

Moreover, according to the present embodiment, since the tan δ (60° C.) of the cap tread rubber 11A is 0.10 or more and 0.30 or less, rubber having a relatively high viscosity can be used as the cap tread rubber 11A, increasing the friction force of the rubber. As a result, gripping force of the tread portion 1 can be improved, and the steering stability can be improved.

Further, accordingto the present embodiment, since the average groove depth GD of the main groove 10 and the gauge CPGaofthe cap tread rubber 11A satisfy the relationship 1.0 ≤ (GD/CPGa) ≤ 1.3, the gauge CPGa of the cap tread rubber 11A can be optimized with respect to the average groove depth GD of the main groove 10, and the steering stability can be improved.

Furthermore, according to the present embodiment, 50 parts by mass or more of carbon black having a nitrogen adsorption specific surface area N₂SA of 70 m²/g or less is blended per 100 parts by mass of a rubber component comprising 50 mass% or more natural rubber and 35 mass% or more and 50 mass% or less terminal-modified butadiene rubber into the undertread rubber 11B, and a modulus of repulsion elasticity of the undertread rubber 11B at 40° C. is 80% or more. As a result, the rigidity of the tread portion 1 is ensured and good steering stability can be ensured. In addition, the rolling resistance coefficient can be reduced.

### EXAMPLES

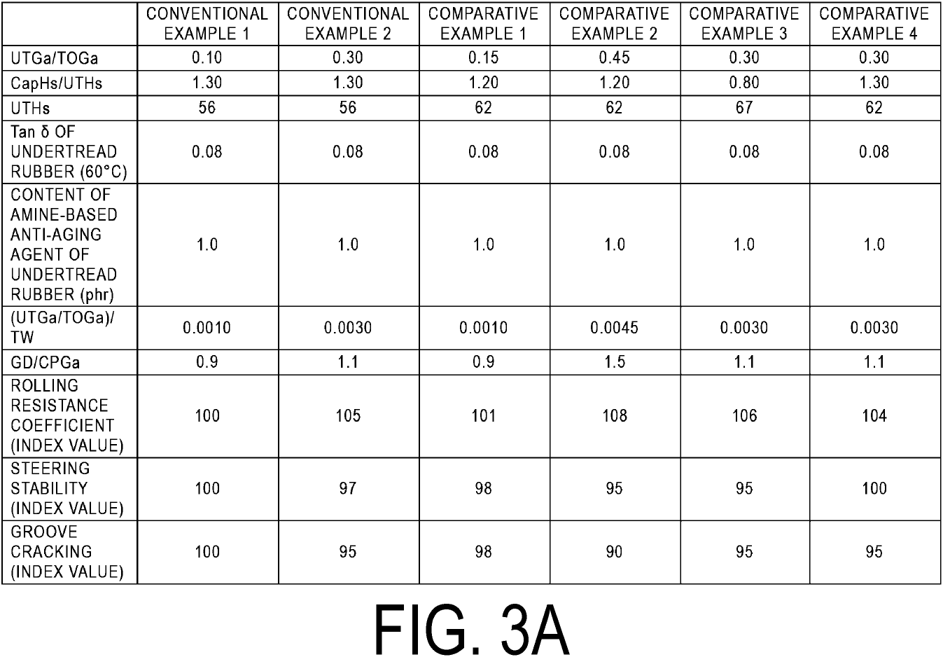

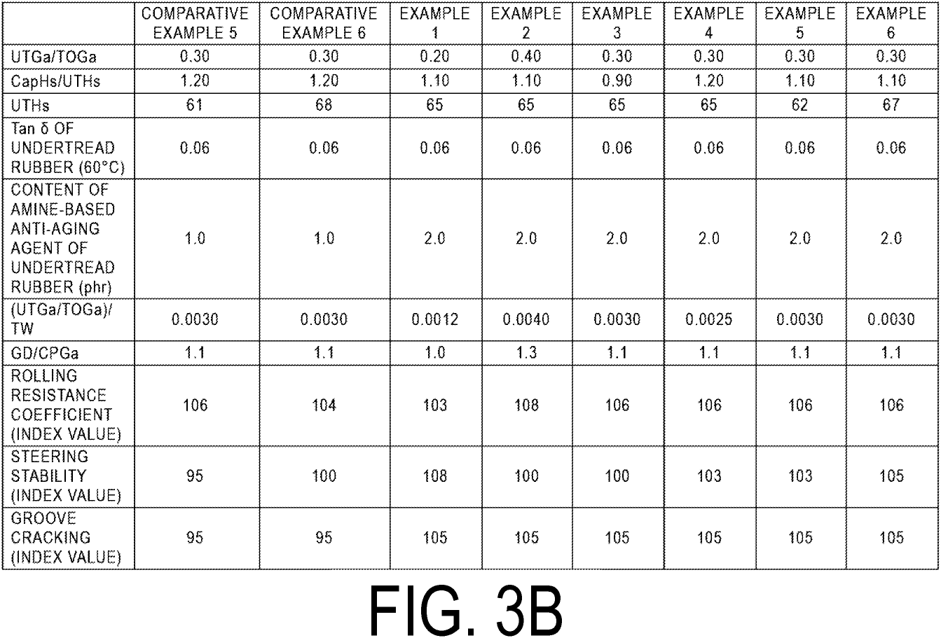

FIGS. 3A-3B include a table indicating the results of performance tests of pneumatic tires according to the present embodiment. In the performance tests, steering stability, rolling resistance coefficients, and groove cracking were evaluated for a plurality of types of test tires. In each of the test tires, a tread rubber layer 11 disposed in a tread portion 1 includes a cap tread rubber 11Alocated on the outermost side in a tire radial direction, and an undertread rubber 11B located adjacent to an inner side in the tire radial direction of the cap tread rubber 11A. The tires according to Examples 1 to 6 and according to Comparative Examples 1 to 6 were manufactured, having a relationship UTGa/TOGa between a total gauge TOGa of the cap tread rubber 11A and the undertread rubber 11B and a gauge UTGa of the undertread rubber 11B, a relationship CapHs/UTHs between a hardness CapHs of the cap tread rubber 11A and a hardness UTHs of the undertread rubber 11B, a hardness UTHs of the undertread rubber 11B, the content of an amine-based anti-aging agent of the undertread rubber 11B, a relationship between the aforementioned UTGa/TOGa and a tread width TW, and a relationship GD/CPGa between an average groove depth GC of a main groove and a gauge CPGa of the cap tread rubber 11A, as illustrated in FIGS. 3A-3B. Conventional Examples 1 and 2 provided with an undertread rubber having low hardness were prepared for comparison.

The test tires have a tire size 155/65R 14 75S. For the test tires, rolling resistance coefficients, steering stability, and groove cracking are evaluated by the following test methods, and the results are indicated in FIGS. 3A-3B. In the evaluation of rolling resistance coefficients, each of the test tires was assembled on a wheel having a rim size of 14×4.5J and mounted on a drum testing machine, and rolling resistance coefficients were measured under an air pressure of 240 kPa in accordance with ISO (International Organization for Standardization) 25280. The evaluation results are expressed as index values using reciprocals of measurement values, with Conventional Example 1 being assigned an index value of 100. Larger index values indicate smaller rolling resistance coefficients and superior results.

In the evaluation of steering stability, each of the test tires was assembled on a wheel having a rim size of 14× 4.5J, inflated to an air pressure of 240 kPa, mounted on a passenger vehicle, and driven on a test course having a dry road surface, and sensory evaluation was performed by a test driver. In addition, the results are expressed as index values with Conventional Example 1 being assigned the value of 100. Larger index values indicate superior steering stability.

In the evaluation of groove cracking, each of the test tires was assembled on a wheel having a rim size of 14×4.5J, inflated to an air pressure of 240 kPa, and left for 24 hours in a test room supplied with ozone, and groove cracks formed in the main groove were measured. The evaluation results are expressed as index values using reciprocals of measurement values, with Conventional Example 1 being assigned an index value of 100. Larger index values indicate fewer occurrences of groove cracking and superior results.

As can be seen from FIGS. 3A-3B, the tires according to Examples 1 to 6 can achieve a reduction in the rolling resistance coefficient and the occurrence of groove cracking while ensuring good steering stability in contrast to Conventional Example 1. Meanwhile, since the tires according to Comparative Examples 1 to 6 do not satisfy the predetermined conditions, the effect of providing steering stability, the rolling resistance coefficient, and groove cracking in a compatible manner is not sufficiently obtained. Additionally, the tire according to Conventional Example 2 is a so-called studless tire including the undertread rubber having low hardness and relatively high thickness compared with Conventional Example 1, and in this case, steering stability is ultimately deteriorated.

1. A pneumatic tire, comprising:
a tread portion extending in a tire circumferential direction and having an annular shape; and
a plurality of main grooves formed in the tread portion and extending in the tire circumferential direction,
the tread portion comprising a cap tread rubber disposed at least on an outer side in a tire radial direction, and an undertread rubber disposed on an inner side in the tire radial direction of the cap tread rubber,
a total gauge TOGa of the cap tread rubber and the undertread rubber and a gauge UTGa of the undertread rubber satisfying a relationship 0.20 ≤ UTGa/TOGa ≤ 0.40 in a ground contact region defined by a pair of the main grooves located on both outermost sides in a tire width direction in the tread portion,
a hardness UTHs of the undertread rubber being in a range of 62 or more and 67 or less, the hardness UTHs of the undertread rubber and a hardness CapHs of the cap tread rubber satisfying a relationship 0.90 ≤ CapHs/UTHs ≤ 1.20, and
a tan δ (60° C.) of the undertread rubber being less than 0.06.

2. The pneumatic tire according to claim 1, wherein the undertread rubber contains an amine-based anti-aging agent of 2.0 phr or more.

3. The pneumatic tire according to claim 1, wherein the cap tread rubber contains an amine-based anti-aging agent of 2.0 phr or more.

4. The pneumatic tire according to claim 1 , wherein a content CPM of the amine-based anti-aging agent of the cap tread rubber and a content UTM of the amine-based anti-aging agent of the undertread rubber satisfy a relationship 0.5 ≤ (UTM/CPM) ≤ 1.5.

5. The pneumatic tire according to claim 1 , wherein the total gauge TOGa of the cap tread rubber and the undertread rubber, the gauge UTGa of the undertread rubber, and a tread width TW of the tread portion satisfy a relationship 0.0012 ≤ (UTGa/TOGa)/TW ≤ 0.0040.

6. The pneumatic tire according to claim 1 , wherein a tan δ (60° C.) of the cap tread rubber is 0.10 or more and 0.30 or less.

7. The pneumatic tire according to claim 1 , wherein an average groove depth GD of the main groove and a gauge CPGa of the cap tread rubber satisfy a relationship 1.0 ≤ (GD/CPGa) ≤ 1.3.

8. The pneumatic tire according to claim 1 , wherein 50 parts by mass or more of carbon black having a nitrogen adsorption specific surface area N₂SA of 70 m²/g or less is blended per 100 parts by mass of a rubber component comprising 50 mass% or more natural rubber and 35 mass% or more and 50 mass% or less terminal-modified butadiene rubber into the undertread rubber, and
a modulus of repulsion elasticity of the undertread rubber at 40° C. is 80% or more.

9. The pneumatic tire according to claim 1 , wherein the pneumatic tire is a summer tire or an all-season tire.

10. The pneumatic tire according to claim 2, wherein the cap tread rubber contains an amine-based anti-aging agent of 2.0 phr or more.

11. The pneumatic tire according to claim 10, wherein a content CPM of the amine-based anti-aging agent of the cap tread rubber and a content UTM of the amine-based anti-aging agent of the undertread rubber satisfy a relationship 0.5 ≤ (UTM/CPM) ≤ 1.5.

12. The pneumatic tire according to claim 11, wherein the total gauge TOGa of the cap tread rubber and the undertread rubber, the gauge UTGa of the undertread rubber, and a tread width TW of the tread portion satisfy a relationship 0.0012 ≤ (UTGa/TOGa)/TW ≤ 0.0040.

13. The pneumatic tire according to claim 12, wherein a tan δ (60° C.) of the cap tread rubber is 0.10 or more and 0.30 or less.

14. The pneumatic tire according to claim 13, wherein an average groove depth GD of the main groove and a gauge CPGa of the cap tread rubber satisfy a relationship 1.0 ≤ (GD/CPGa) ≤ 1.3.

15. The pneumatic tire according to claim 14, wherein 50 parts by mass or more of carbon black having a nitrogen adsorption specific surface area N₂SA of 70 m²/g or less is blended per 100 parts by mass of a rubber component comprising 50 mass% or more natural rubber and 35 mass% or more and 50 mass% or less terminal-modified butadiene rubber into the undertread rubber, and
a modulus of repulsion elasticity of the undertread rubber at 40° C. is 80% or more.

16. The pneumatic tire according to 15, wherein the pneumatic tire is a summer tire or an all-season tire.
